(19) United States
(12) Patent Application Publication
(10) Pub. No.: US 2009/0027379 A1
(43) Pub. Date: Jan. 29, 2009

(54) IMAGING SYSTEM

(75) Inventors: Chuan Zheng, Bedford, MA (US); Olivier Gerard, Viroflay (FR); Pascal Allain, Versailles (FR); Damien Jean-Jacques Dolimier, Orleans (FR)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/572,999

(22) PCT Filed: Jul. 13, 2005
(86) PCT No.: PCT/IB05/52328

§ 371 Date: Jan. 31, 2007

(30) Foreign Application Priority Data
Aug. 5, 2004 (US) 60599090

(51) Int. Cl. G06T 15/00

(52) U.S. Cl. 345/419

(57) ABSTRACT

The present invention relates to an imaging system for displaying image data representative of a structure investigated by scan image data acquisition means. The imaging system comprises display rendering means for processing scan data representative of the configuration of the structure and rendering a display comprising a 3D image of the structure superposed with a scan image representative of the extent of the scan region.

### FIELD OF THE INVENTION

The present invention relates to an imaging system and particularly but not solely to an imaging system for use in medical applications.

### BACKGROUND OF THE INVENTION

Investigation of the structure of internal organs or other structures using medical imaging techniques is well known. Such techniques include, inter alia, Ultrasound scanning, CT and MRI. Exemplary ultrasound techniques are disclosed in for example WO/2004049952.

The stretching of the Left Ventricle (LV) during the cardiac cycle is known to be related to cardiac health. Imaging technology enables static volume (3D) images and dynamic volume (4D) images to be generated. Cardiac imaging systems such as Ultrasound, CT or MRI Imaging have been developed to image the LV during the cardiac cycle. Clinicians derive benefit from quantitative and qualitative information that can be derived from such imaging systems.

An improved modality of visualisation has now been devised.

### SUMMARY OF THE INVENTION

It is an object of the present invention to provide a modality of visualisation enabling an observer to interact with and/or observe an image display providing useful technical understanding relating a plurality of image views, or the location in 3D of a structure.

According to a first aspect, the present invention provides an imaging system for displaying image data representative of a structure investigated by scan image data acquisition means, the imaging system comprising display rendering means for processing scan data representative of the configuration of the structure and rendering a display comprising a 3D image of the structure superposed with a scan image representative of the extent of the scan region.

The scan image preferably has a perspective in 3D, and may beneficially comprise a 3D image. The scan image is desirably therefore representative of the acquired volume of the scan. The acquired volume is the volume in 3 dimensions over which scan data can be recovered. The composite image comprising the 3D image of the structure superposed with the scan image enables the relative orientation of the structure with respect to the scan region (acquired volume) to be conveniently displayed.

This has benefits in enabling the observer to ensure that the scan data acquisition means (for example an ultrasound scan device or array) is optimally located. A clinician, for example, can use the invention to ensure that the structure under investigation (for example the LV) is entirely positioned in the scan 3D acquired volume.

The scan image preferably comprises an image of a scan plane intersecting the 3D image of the structure. In a preferred embodiment, the structure has a long axis and the scan plane intersects the 3D image transversely to the long axis. This is preferred for LV investigation, where the scan image preferably includes a scan plane which is perpendicular to the long axis of the LV. Beneficially, the scan image comprises orthogonal scan planes intersecting the 3D image of the structure.

In a preferred embodiment, the display rendering means renders a display having a plurality of view panes such that;
a first view pane displays a 3D image of the structure and superposed with the 3D image of the structure a scan image representative of the scan investigated region; and
a second view pane displays a 2D scan image corresponding to the scan image of the first view pane.

According to a further aspect, the present invention provides A method of rendering scan image data, the method comprising processing scan data and rendering a display comprising a 3D image of a structure present in the scan region and superposed with the 3D image of the structure, a scan image representative of the extent of the scan region.

According to a further aspect, the present invention provides a method of imaging the left ventricle (LV) of a heart, the method comprising rendering a display comprising a 3D image of the LV and superposed with the 3D image of the LV, a scan image representative of the extent of the scan region.

According to a further aspect, the invention provides a computer program product comprising a set of instructions enabling performance of the method.

These and other aspects of the invention will be apparent from and will be elucidated with reference to the embodiments described hereinafter.

### BRIEF DESCRIPTION OF THE DRAWINGS

The present invention will now be described in more detail, by way of example, with reference to the accompanying drawings, wherein:

FIG. 1 is an exemplary view of an imaging system display according to the present invention; and,

FIG. 2 is a 3D representation of the superposition of images of FIG. 1,

FIG. 3 is a schematic representation of the data acquisition system.

### DETAILED DESCRIPTION OF THE INVENTION

An exemplary ultrasonic imaging technique is disclosed by WO2004003851. Data acquisition for the present invention, may be achieved using a 3D echocardiography examination system, comprising means for acquiring 3D volume digital data, and is associated with a digital processing system for processing the acquired 3D volume data. The examination system 550 shown in FIG. 3 comprises means for providing data to the processing system which has at least one output 506 to provide image data to display and/or storage means 530,540. The display and storage means may respectively be the screen and memory of a workstation 510. The workstation 510 may also comprise a keyboard 531 and a mouse 532.

The image processing system 520 may be a suitably programmed computer of a workstation 510, or a special purpose processor having circuit means such as filters, logic operators and memories, that are arranged to perform the functions of the method steps according to the invention. The processing system 520 may use a computer program product having program instructions to be executed by the computing means of the processing system 520 in order to carry out the method steps. The data processing system, display and/or storage means may be located remotely from the data acquisition means of the system.

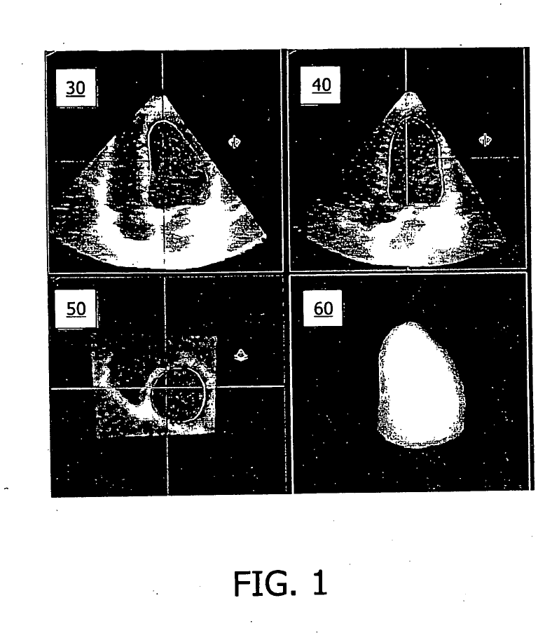

Following the acquisition stage, the 3D volume data is manipulated and processed to generate display images as shown in FIG. 1. Referring to FIG. 1, cross-sectional ultrasound images of the left ventricle (LV) of a patient's heart are shown from three orthogonal display perspectives 30, 40, 50, each being superposed with the computer generated border (which highlights the inner periphery of the LV) corresponding to each image plane. The fourth display pane 60 illustrates the 3D volume image of the LV.

A problem with 2D display images however, is that it is difficult to appreciate the position of the relevant ultrasound image plane within the body being investigated. FIG. 1 shows three display panes 30, 40, 50 of a cross-section of the LV, but there no useful indication to the user of the position of the cross-section within the body of the LV.

In order to analyse a 2D cross-sectional image of a body in a manner which exposes the position of the cross-section within the body, it is necessary to superpose the 2D image view within the 3D volume.

According to the present invention, the imaging system as described enables a display to be rendered showing a 3D image view of the LV superposed with an image of one or more planes related to the scan volume. The system allows the user to interact with a 2D image plane and display an image plane onto a position within the 3D volume. The interaction further provides the visualisation of the changes associated with the computer generated border on the image plane as it is moved through the body of the LV and thus also provides a means for data validation.

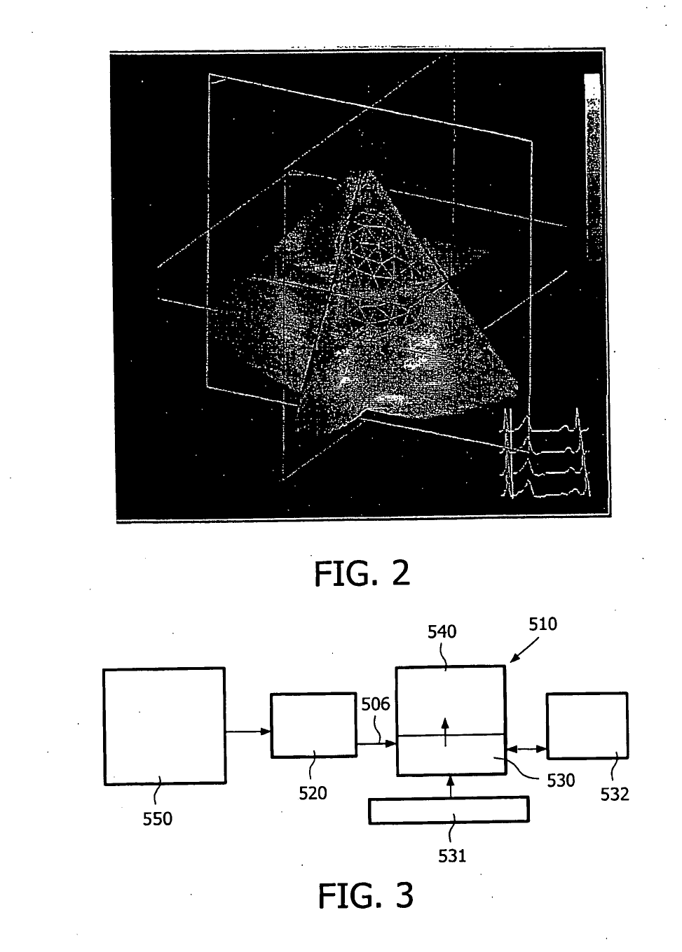

The simultaneous display of the 3D reference image of the LV 60 superposed with the 2D orthogonal ultrasound image panes 30, 40, 50 is rendered as shown in FIG. 2. The imaging system provides the user with an appreciation of the global orientation of the LV within the scan region defined by the orthogonal 2D scan images and is thus a useful tool in 3D quantification.

In a preferred realisation, the display comprises display panes 30, 40, 50 as shown in FIG. 1, but with pane 50 replaced by the pane of FIG. 2, in which at image pane 60, the 3D image of the LV structure is superposed with the images of the planes corresponding to the image views of image panes 30, 40, 50. This arrangement enables the 2D image to be easily understood with respect to the 3D image view at pane 60.

It should be noted that the above-mentioned embodiments illustrate rather than limit the invention, and that those skilled in the art will be capable of designing many alternative embodiments without departing from the scope of the invention as defined by the appended claims. In the claims, any reference signs placed in parentheses shall not be construed as limiting the claims. The word “comprising” and “comprises”, and the like, does not exclude the presence of elements or steps other than those listed in any claim or the specification as a whole. The singular reference of an element does not exclude the plural reference of such elements and vice-versa. The invention may be implemented by means of hardware comprising several distinct elements, and by means of a suitably programmed computer. In a device claim enumerating several means, several of these means may be embodied by one and the same item of hardware. The mere fact that certain measures are recited in mutually different dependent claims does not indicate that a combination of these measures cannot be used to advantage.

1. An imaging system for displaying image data representative of a structure investigated by scan image data acquisition means, the imaging system comprising display rendering means for processing scan data representative of the configuration of the structure and rendering a display comprising a 3D image of the structure superposed with a scan image representative of the extent of the scan region.

2. An imaging system according to claim 1, wherein the scan image has a perspective in 3D.

3. An imaging system according to claim 1, wherein the scan image is representative of the acquired volume of the scan.

4. An imaging system according to claim 1, wherein the image displays the relative orientation of the structure with respect to the scan region.

5. An imaging system according to claim 1, wherein the scan image comprises an image of a scan plane intersecting the 3D image of the structure.

6. An imaging system according to claim 5, wherein the structure has a long axis and the scan image comprises a plane which intersects the 3D image transversely to the long axis.

7. An imaging system according to claim 1, wherein the scan image comprises orthogonal scan planes intersecting the 3D image of the structure.

8. An imaging system according to claim 1, wherein the display rendering means renders a display having a plurality of view panes such that;
a first view pane displays a 3D image of the structure and superposed with the 3D image of the structure a scan image representative of the scan investigated region; and
a second view pane displays a 2D scan image corresponding to the scan image of the first view pane.

9. An imaging system according to claim 1 wherein the structure comprises the left Ventricle (LV) of a heart.

10. An imaging system according to claim 1, wherein the 3D image represents the boundary of the structure.

11. An imaging system according to claim 1, including scan image data acquisition means for acquiring the scan data.

12. An imaging system according to claim 11, wherein an ultrasound scan system is used to acquire the scan data.

13. A method of rendering scan image data, the method comprising processing scan data and rendering a display comprising a 3D image of a structure present in the scan region and superposed with the 3D image of the structure, a scan image representative of the extent of the scan region.

14. A method of imaging the left ventricle (LV) of a heart, the method comprising rendering a display comprising a 3D image of the LV and superposed with the 3D image of the LV, a scan image representative of the extent of the scan region.

15. A computer program product comprising a set of instructions for carrying out a method according to claim 13 or claim 14.
